(19) United States
(12) Patent Application Publication
(10) Pub. No.: US 2002/0101106 A1
(43) Pub. Date: Aug. 1, 2002

(54) No-back drive mechanism for use with aircraft seat actuators

(76) Inventors: Stephen E. Kim, Valencia, CA (US); Aaron Sabouri, Sherman Oaks, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/775,399

(22) Filed: Feb. 1, 2001

(51) Int. Cl. B60N 2/22

(52) U.S. Cl. 297/362.11

(57) ABSTRACT

A no-back drive mechanism for use in aircraft seat actuator assemblies. The mechanism provides a general interface between an electric motor and a seat actuator. The mechanism prevents an aircraft seat actuator from back driving under passenger induced loads on the seat. The no-back drive mechanism comprises an input member, an output member, and a housing. The input and output members include driving and driven members respectively. The driven members include cam surfaces on which ride rolling members. The cam surfaces are designed to cause the rolling members to wedge against the cam surfaces and the housing when the output member experiences either clockwise or counter-clockwise rotation due to passenger induced loads on the aircraft seat actuator assembly. The driving members of the input member, by contrast, include features which disengage the rolling members from their locked positions and transmit torque to the driven members of the output member, thereby allowing the input member to freely drive the output member in both clockwise and counter-clockwise directions.

### BACKGROUND OF THE INVENTION

The present invention relates to the field of anti-back drive mechanisms, and more particularly to an anti-back drive mechanism for use with aircraft seat actuators.

Seats used in commercial aircraft are typically equipped with a seat portion, a seat-back pivotally connected to the seat portion, and with an actuator which allows a passenger to recline the seat-back at various times during an aircrafts flight. Typically, for safety reasons, aircraft seats are required to be in a full upright position during takeoffs and landings. However, in order to achieve a greater degree of comfort than that obtainable when the seat-back is in the full upright position, passengers are typically permitted to recline the seat during the flight interval between takeoff and landing. However, regardless of whether a seat-back is in the full upright position or has been reclined, Federal Aviation Administration (“FAA”) regulations require that the seat-back, once set, must remain in place in response to loads induced upon the seat by aircraft accelerations acting on a passenger's weight. For this reason, the actuator assemblies which are used to recline aircraft seat-backs must be equipped with an anti-back drive or no-back drive mechanism. A typical seat-back actuator assembly includes an electric motor which drives a geartrain which drives a lead screw. The actuator assembly is generally attached to the seat portion with the lead screw extending rearward. The lead screw is attached to the seat-back. Generally, clockwise rotation of a nut within the actuator drives the lead screw forward causing the seat-back to recline, and counterclockwise rotation of the nut drives the lead screw backwards thereby raising the seat-back. Without a no-back drive device, passenger induced loads on the seat-back are transmitted through the nut to the lead screw causing the lead screw to back-drive or recline the seat from its intended position, which may thereby pose a safety hazard. Back driving is also undesirable in that back driving increases actuator geartrain stresses and consequently reduces the life of the actuator. In addition, back driving of the actuator creates substantial noise which is typically disturbing to aircraft passengers and is therefore undesirable in any application. Thus, a no-back drive device is an essential component of an aircraft seat actuator.

Generally, there are two prior art approaches to developing reclining aircraft seats with no-back drive capability. In the first approach, a worm gear drive is used in the seat actuator. Worm gear drives suffer from high frictional losses and therefore are only about 30 to 60% efficient. However, one advantage of the high friction inherent in a worm gear drive is that drives with lead angles exceeding about ten degrees will inherently not-back drive under passenger induced loads. The disadvantage of worm gear drives is that they require large electric motors in comparison to helical and/or spur gear drives to develop the starting torque required to actuate the drive. The second prior art approach to developing an aircraft seat with no-back drive capability has been to use relatively efficient helical or spur gears in the actuator geartrain and to couple this form of drive to an electromechanical brake. Helical and spur gear drives are about 80 to 95% efficient and thus require substantially less torque to operate the drive, thereby allowing the use of smaller motors than can be used with a comparable worm gear drive. However, due to their high efficiency, helical and spur gear drives will back drive under passenger induced loads. To prevent back driving, an electromechanical brake must be incorporated in the drive. The need for an electromechanical brake, which has its own electrical power requirements, negates to some extent the advantage in efficiency helical and spur gear drives possess over worm gear drives.

What is needed therefore is a comparatively simple no-back drive mechanism that may replace the electromechanical brakes used in aircraft seat actuators which utilize efficient spur and helical gear drives. Ideally, such a device would be purely mechanical in nature and would therefore eliminate the electrical power drain caused by electromechanical brakes and would therefore increase the overall efficiency of a spur or helical gear drive actuator.

### SUMMARY OF THE INVENTION

The present invention is an anti-back drive or no-back drive mechanism for use in aircraft seat actuator assemblies. The no-back drive mechanism serves as a general interface between an electric motor and an actuator in an aircraft seat actuator assembly. The mechanism prevents an aircraft seat actuator from back driving under passenger induced loads on the seat. The no-back drive mechanism is a mechanical device that is intended to replace the electromechanical brakes presently used in actuator assemblies that employ efficient spur and helical gear drives. Generally, the no-back drive mechanism comprises an input member, an output member, a plurality of rolling members, and a housing. The input member includes a number of driving members which interface with an equal number of driven members on the output member. The driven members include cam surfaces on which ride the rolling members. The cam surfaces are designed to cause the rolling members to wedge against the cam surfaces and the housing when the driven members of the output member experience either clockwise or counter-clockwise rotation due to passenger induced loads on the aircraft seat actuator assembly. The driving members of the input member, by contrast, include features which disengage the rolling members from their locked positions and transmit torque to the driven members of the output member, thereby allowing the input member to freely drive the output member in both clockwise and counter-clockwise directions. Other features and advantages of the invention will become more apparent from the following detailed description of the invention, when taken in conjunction with the accompanying exemplary drawings.

### BRIEF DESCRIPTION OF THE DRAWINGS

FIG. 1 is a perspective view of an aircraft seat with an actuator assembly which includes a no-back drive mechanism embodying features of the present invention.

FIG. 2 is a perspective view of the aircraft seat actuator assembly shown in FIG. 1.

FIG. 3 is a perspective view of a no-back drive mechanism in accordance with the present invention.

FIG. 4 is an exploded view of the no-back drive mechanism shown in FIG. 3.

FIG. 5 is a cross-sectional view, taken along the line A-A, of the no-back drive mechanism shown in FIGS. 3 and 4 with the input shaft shown in the drive position.

FIG. 6 is a cross-sectional view, taken along the line A-A, of the no-back drive mechanism shown in FIGS. 3 and 4 with the output shaft shown in the locked position.

FIG. 7 is a cross-sectional view, taken along the line A-A, of an alternative embodiment of no-back drive mechanism shown in FIG. 3 with the input shaft shown in the drive position.

FIG. 8 is a cross-sectional view, taken along the line A-A, of an alternative embodiment of no-back drive mechanism shown in FIG. 3 with the output shaft shown in the locked position.

### DETAILED DESCRIPTION OF THE PREFERRED EMBODIMENTS

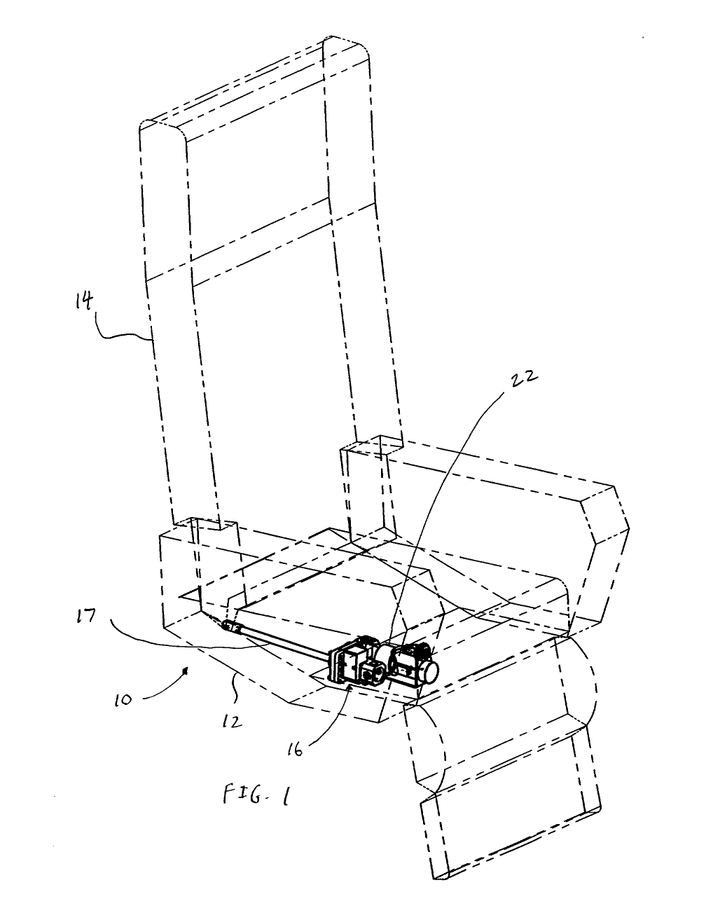

Referring now to FIG. 1, there is shown an aircraft seat 10 which comprises a seat portion 12 and a seat-back 14 pivotally connected to the seat portion. Attached to the seat portion is an electromechanical actuator assembly 16. Integrated with the actuator assembly is a no-back drive mechanism 22 in accordance with the present invention. Coupled to and extending from the actuator is a lead screw 17. The lead screw is coupled to the seat-back in such a manner that the actuator may drive the seat-back up or down, i.e., the actuator may recline or raise the seat-back.

Although, the no-back drive mechanism 22 of the present invention is shown and described as being integrated with an electromechanical actuator assembly for use in reclining a seat-back, the no-back drive mechanism is not intended to be limited to this type of actuator. Rather, the no-back drive mechanism of the present invention is intended to serve as a general interface between an electric motor and an aircraft seat actuator. The mechanism is suitable for use with any form of aircraft seat actuator where anti-back drive capability is desired.

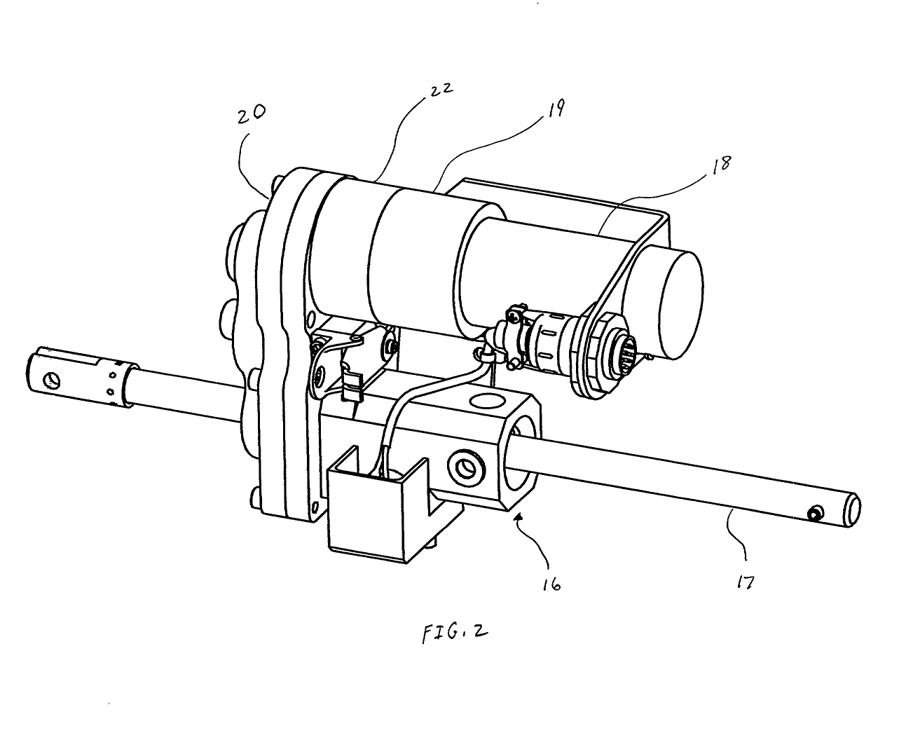

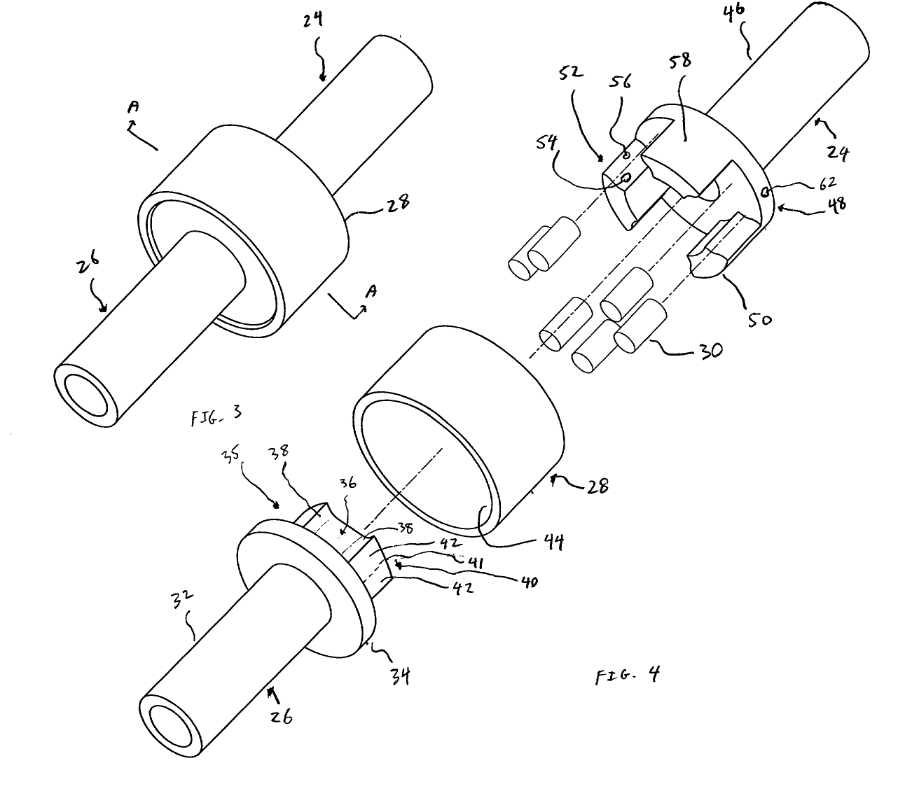

Referring now to FIG. 2, the aircraft seat actuator assembly 16 is shown. The assembly includes a motor 18 having an output shaft (not shown) and an actuator 20. The actuator includes an input gear or pinion gear (not shown) and an output such as the lead screw 17. Providing an interface between the motor and the actuator is the no-back drive mechanism 22. The actuator assembly may also include a gear box 19 disposed between the motor and the no-back drive mechanism as shown in FIG. 2. In a typical installation, an input shaft 46 (FIGS. 3 and 4) of the no-back drive mechanism is coupled to the motor output shaft, and an output shaft 32 of the no-back drive mechanism (FIGS. 3 and 4) is coupled to the pinion gear of the actuator. As will be explained below, the output shaft of the no-back drive mechanism, and thus the actuator geartrain, is locked against back driving. In this manner, the no-back drive mechanism prevents passenger induced loads, such as a passenger being pressed against the seat-back 14 due to a sudden aircraft acceleration, from back driving the actuator assembly and thereby causing the seat-back to recline beyond its set position and into a potentially hazardous position.

Referring now to FIGS. 3 and 4, there is shown the no-back drive device of the present invention 22. The device comprises generally an input member 24, an output member 26, a housing 28, and rolling members 30. In the exemplary embodiments, the rolling members are cylindrical rollers. However, those skilled in the art will understand that other forms of rolling members, such as balls, may be substituted for cylindrical rollers. The input member 24 comprises the input shaft 46 integrally formed at an upper end of the input member. The input shaft is depicted as a hollow cylindrical member, for purposes of illustration only. Those skilled in the art will understand that the actual configuration of the input shaft will vary depending upon the configuration of the output shaft of the particular motor 18 to which the input shaft is to be coupled. The input member also includes an intermediate ring member 48, which has a cylindrical outer surface 62 designed to interface in slip fit relationship with an interior cylindrical surface 44 of the housing 28. Integrally formed with the intermediate ring are three equally spaced driving members 50. Each driving member has a cylindrical outer surface 58 which is cylindrically coplanar with the cylindrical plane defined by the cylindrical outer surface of the intermediate ring member. The outer surfaces of the driving member also interface with the interior cylindrical surface of the housing in slip fit relationship. Each side of each driving member is formed as a generally S-shaped surface 52. The inner portion of the generally S-shaped surface forms a radially inner abutment face 54, and the outer portion of the S-shaped surface forms a radially outer abutment face 56. While the sides of the driving members have been described as being generally S-shaped in configuration, this is not meant to be limiting as other configurations are practical. What is important is that the sides of the driving members have an inner abutment face and an outer abutment face, where the inner abutment face is stepped tangentially inwardly from the outer abutment face.

With continued reference to FIGS. 3 and 4, the output member 26 comprises the output shaft 32 integrally formed at a lower end of the output member. The output shaft is depicted, for purposes of illustration only, as a hollow cylindrical member. Those skilled in the art will understand that the configuration of the output shaft will vary according to the configuration of the pinion gear of each particular actuator 20 to which the output shaft is to be coupled. The output member also includes an intermediate member 34, which is designed to interface in slip fit relationship with the interior cylindrical surface 44 of the housing 28. The output member further includes an engagement portion 35 integrally formed at an upper end of the output member. The engagement portion includes three equally spaced driven members 40. Each driven member includes a pair of adjacent cam surfaces 42. Each pair of adjacent cam surfaces meet at an apex 41. Opposite each driven member is an arcuate recess 36. The ends of each recess form radially inner abutment faces 38.

Although, the embodiment of the no-back drive device described above uses three driving and driven members 50 and 40 respectively. The device may be constructed using only one driving and one driven member. However, it is preferable that the device include at least two equally spaced driving and driven members. The maximum number of driving and driven members is limited only by the packaging and load requirements of a particular application. Further, it should be noted that embodiments of the device may be constructed where the driving members indirectly drive the driven members. For example, via a rolling member disposed between each driving and driven member.

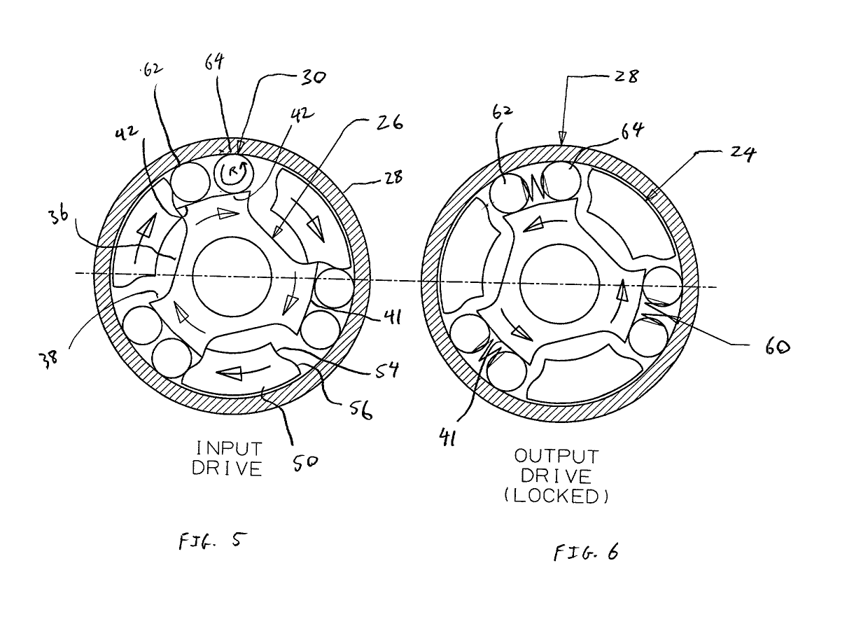

Referring now to FIGS. 3-6, the no-back drive mechanism 22 of the present invention is assembled as follows. The input member 24 and the output member 26 are slid within the housing 28 such that each driving member 50 of the input member is disposed within one of the arcuate recesses 36 of the engagement portion 35 of output member. Correspondingly, each driven member 40 of the output member is disposed in a corresponding space formed between each adjacent driving member of the input member. Prior to mating the input and output members, one rolling member 30 is placed onto each adjacent cam surface 42 of each driven member. Between each adjacent rolling member 30 is placed a biasing spring 60 (FIG. 6). The geometry of the assembled no-back drive mechanism is best shown in FIGS. 5 and 6.

Referring now to FIGS. 5 and 6, the operation of the no-back drive mechanism 22 of the present invention is as follows. The input member 24 may be driven either clockwise (“CW”) or counter-clockwise (“CCW”). When the input member is driven, the output member 26 is driven, by the input member, in the same direction as the input member. When the input member is stationary the output member is automatically locked against back driving, in either the CW or CCW directions, by the action of the biasing springs 60 acting against the rolling members 30, as will be explained in detail below. In all driving modes the housing 28 is stationary.

For simplicity of description, the driving operation will now be described in terms of one driving member 50 contacting one driven member 40, and to one set of rolling members, to be identified as a near rolling member 62 and a far rolling member 64, placed on the cam surfaces 42 of the driven member, as shown in FIGS. 5 and 6. Those skilled in the art will understand however, that the sequence of operations actually occurs with the three driving members simultaneously contacting the three driven members.

Starting with the no-back drive mechanism 22 in the locked position as shown if FIG. 6, the mechanism is brought into the driving position, as shown in FIG. 5, as follows. When the input member 24 rotates CW, as the inner abutment face 54 of the driving member contacts the inner abutment face 38 of the driven member, the corresponding outer abutment face 56 of the driven member contacts and pushes the near rolling member 62 up the cam surface 42 towards the apex 41 of the pair of adjacent cam surfaces of the driven member, thereby freeing the rolling member from a wedge position. As stated previously, the inner abutment face of the driving member is stepped inwardly from the outer abutment face, therefore the outer abutment face will have contacted and pushed the near rolling member up the cam surface and out of the wedge position before the inner abutment face of the driving member contacts the abutment face of the driven member, thus freeing the output member to rotate with the input member. Therefore, as the inner abutment face of the driving member contacts the corresponding inner abutment face of the driven member, as shown in FIG. 5, torque from the input member is transferred to the output member thereby driving the output member.

It will be observed that as the upper abutment face 56 pushes the near rolling member 62 up the cam surface 42, the biasing spring maintains the far rolling member 64 in contact with both the inner surface 44 of the housing 28 and the opposite cam surface. However, as can be seen, the direction of motion of the far rolling member is tangentially opposite to the rotation of the input shaft, or inwards towards the near rolling member and away from the cylindrical wall of the housing. Therefore, wedging of the far rolling member against the cam surface and the housing is prevented. It will also be observed, that the abutment faces on each end of the driving and driven members are mirror images of each other. Therefore, the sequence of operations for CCW rotation of the driving and driven members is identical to that of CW rotation and further explanation is not required.

Now, starting with the no-back drive mechanism 22 in the driving position as shown in FIG. 5, the mechanism automatically enters the locked position as shown in FIG. 6, as follows. Again, for simplicity of description, reference will be made to only one driven member 40 and one set of rolling members to be identified as the near rolling member 62 and the far rolling member 64. Again, those skilled in the art will understand that the sequence of operations actually occurs at all three driven members simultaneously. At a time just prior to when the input member stops driving, for example when a passenger is about to finish reclining his seat, the driving member 50, the driven member 40, and the rolling members 62 and 64 will be in the position depicted in FIG. 5. When the motion of the input member and consequently the driving member stops, the biasing spring 60 will bias the rolling members 62 and 64 down the adjacent cam surfaces 42. As the rolling members travel down the cam surfaces, or away from the apex 41 of the cam surfaces, they are forced into a wedge position between the cam surfaces and the inner wall 44 of the housing 28, as shown in FIG. 6.

It will be observed from FIG. 6, that each of the rolling members 62 and 64 overhangs its respective cam surface 42 by a predetermined distance. Thus, when the rolling members are in the driving position as shown in FIG. 5, as soon as the motion of the driving member 50 stops, the biasing spring 60 forces the near rolling member against the upper abutment face 56 of the driving member. This force in turn causes the driven member 40 to rotate slightly away from the driving member, thereby providing space for the biasing spring to snap the rolling members into the wedge or locked position as shown in FIG. 6. When the rolling members are in the locked position, back driving of the output member 26 in the CW direction is prevented by the wedging action of near rolling member 62, and back driving in the CCW direction is prevented by the wedging action of the far rolling member 64. It will be observed that although the upper abutment face of the driven member may maintain contact with the near rolling member 62, since the lower abutment face 54 is stepped tangentially inwardly from the upper abutment face, once the rolling members are in the locked position there is no direct contact between the driving and driven member.

It will further be observed, that although the cam surfaces are depicted as sloping upwardly towards an apex, this is not required for the invention to operate as described. The cam surfaces may in fact slope slightly downwardly towards a vertex, or the cam surfaces may be replaced by a single flat cam surface having a midpoint, without any adverse effects on the anti-back drive capability of the device. In the case of the single flat cam surface, the cam surface should be perpendicular to a radial plane passing through the longitudinal axis of the no back drive mechanism and the midpoint of the single cam surface. What is required for the device to operate is that the cam surface or surfaces cause the rolling members to wedge between the cam surface and the interior wall 44 of the housing 28 at each end of the cam surface as the rolling members travel outwardly from the apex, vertex or midpoint of the cam surface. In other words, the rolling members cannot fall off of the cam surface or surfaces.

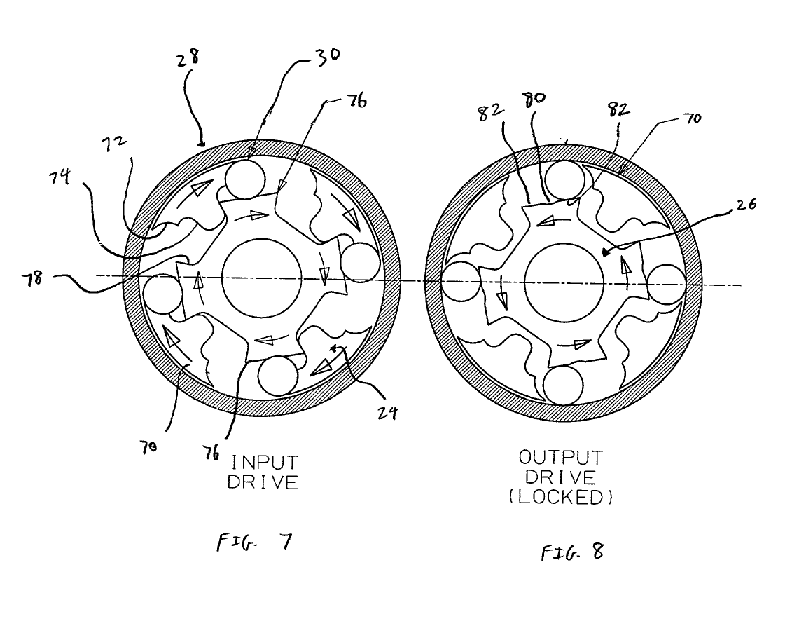

Referring now to FIGS. 7 and 8, there is shown an alternative embodiment of the no-back drive mechanism 22. In this embodiment, the input member 24 has four equally spaced driving members 70. The driving members have an inner abutment face 74 and an outer abutment face 72. The outer abutment face is depicted as being formed with a radius which matches the radius of the rolling members. This is not a requirement however, as the abutment face performs equally well with a shape that produces line contact with the rolling members. Similar to the embodiment depicted in FIGS. 4-6, the inner abutment face is stepped inwardly with respect to the outer abutment face. In the alternative embodiment, the output member 26 includes four equally spaced driven members 76. Each driven member has an inner abutment face 78 on each side. Each driven members also includes a pair of adjacent cam surfaces 82. Here, the cam surfaces slope downwardly and meet at a vertex 80. The vertex 80 is in the form a radius which matches the radius of the rolling members 30 and forms a rest position for the rolling members. Although, the vertex is depicted as having a radius in the exemplary alternative embodiment, this is not a requirement for proper operation of the mechanism. Also, as described in the previous embodiment, the cam surfaces may slope upwardly or downwardly, or may be replaced by a single flat cam surface, without adverse effect on the functioning of the device.

The driving members 70 and the driven members 76 are integrally formed as part of the respective input and output members, and other than as described, are generally similar to the driving and driven members described in the embodiment depicted in FIGS. 4-6. The most significant difference between the alternative embodiment and the embodiment depicted in FIGS. 4-6, is that in the alternative embodiment, only a single rolling member 30 is used with each driven member. Therefore, the single rolling member must provide wedging action to prevent both CW and CCW back driving of the output member. Also, like the embodiment depicted in FIGS. 3-6, the embodiment depicted in FIGS. 7 and 8 may be constructed with less than four pairs of driving and driven members, 70 and 76 respectively, or with more pairs.

The operation of the alternative embodiment of the no-back drive mechanism will now be described in detail. Again, for simplicity of description, reference will be made to only one driving member 70 and only one driven member 76. Again, those skilled in the art will understand that the sequence of operations actually occurs at all four driving and driven members simultaneously. Starting with the output member 26 in the locked position as shown in FIG. 8, when the input member 24 rotates CW the inner abutment face 74 of the driving member contacts the inner abutment face 78 of the driven member and begins to drive the output member 26 in the CW direction. At this time, the rolling member 30 rolls out of a wedge position and down the cam surface 82 and simultaneously comes to rest in the vertex 80 and against the upper abutment face 72 of the driving member, as is shown in FIG. 7. In this position, the rolling member does not contact the inner wall 44 of the housing 28 and CW driving of the output shaft may occur without obstruction. Since the abutment faces on each side of the driving and driven members are mirror images of each other, CCW driving of the output member by the input member is identical in operation to that for CW driving. Thus, further explanation is not required.

In the alternative embodiment, anti-back drive capability is achieved as follows. Reference will again be made to only one driving and one driven member 70 and 76. When the input member 24 stops driving, the relationship between the driving and driven members will be as is shown in FIG. 7. Since the alternative embodiment lacks a second rolling member and the biasing spring 60, automatic locking of the output member 26 does not occur. For locking to occur, a small amount of back driving of the output member and consequently the driven member must occur. As the driven member rotates, either CW or CCW, the rolling member 30 rolls up one of the cam surfaces 82 and wedges between the cam surface and the interior surface 44 of the housing 28, thereby locking the driven member and consequently the output member and stopping the back drive motion.

With respect to materials, those skilled in the art will understand that the component parts of the no-back drive mechanism 22 may be made from numerous materials including but not limited to steel, aluminum, and plastic. Those skilled in the art will also appreciate that the highest contact stresses occur between the rolling members and the driven members of the output member, and the rolling members and the housing. Thus, in high load applications, the rolling members, housing, and output member should be produced from a relatively hard material, such as heat treated, high-alloy steel. The input member on the other hand sees generally lower stresses and may be produced from a softer and typically less expensive material than that used for the other component parts. For example, in the case of high load applications, the input member could be produced from a non-heat treated low-alloy steel.

Constructed in the general manner described and illustrated herein, the no-back drive mechanism of the present invention provides several advantages over the prior art. The no-back drive mechanism provides a general interface between an electric motor and an actuator in an aircraft seat actuator assembly. The mechanism may be adapted for use with a wide variety of aircraft seat actuator assemblies including seat-back reclining actuators, and actuators for raising and lowering foot rests, among others. The no-back drive mechanism does not require any electrical power as required by the electromechanical brakes used on prior art spur and helical gear drive actuator assemblies. In addition, the no-back drive mechanism is able to withstand more back driving torque than electromechanical brakes of comparable size. The no-back drive mechanism of the present invention replaces the prior art electromechanical brakes and thereby increases the efficiency of actuator assemblies that utilize spur or helical type gear drives by reducing their demand for electrical power.

A further advantage of the no-back drive device 22 over prior art electro-mechanical brakes is the ability of the no-back drive device to eliminate motor control errors caused by passenger assisted loading. Passenger assisted loading may occur when the seat-back 14 is reclined. As the seat-back is reclined, the passenger's weight essentially provides the force necessary to recline the seat. Therefore, the drive motor 18 of the actuator assembly 16 sees very little load during this operation. In some circumstances, such as when a passenger forcefully reclines the seat, or when a particularly heavy passenger reclines the seat, the seat-back will be reclined faster than the predetermined speed of the motor causing the motor to be over-driven. When the motor is over-driven, it tends to function as an electrical generator and consequently produces an electrical signal which may create a control error in the motor controller. In addition, when the motor is over-driven the seat-back will recline at an uncontrollable speed and may therefore create a safety problem.

The no-back drive device of the present invention 22 eliminates the above described problem. When the no-back drive device is installed as a part of the seat actuator assembly 16 the motor 18 cannot be over-driven as the output member 26 will lock the no-back drive device whenever the output member is driven faster than the input member 24, such as when a passenger forcefully reclines the seat. When the passenger stops applying excess force to the seat, the motor automatically unlocks the no-back drive device allowing the seat-back 14 to continue to recline. In practice, when the motor is over-driven, the seat-back never actually stops reclining. Rather, the no-back drive device continuously locks and unlocks thereby allowing the seat-back to recline at a controlled rate dependent on the motor input speed. This feature allows for user adjustable control of the rate at which the seat-back will recline by varying the motor speed. Such action cannot be duplicated with electro-magnetic brakes without the addition complex control electronics to sense when the motor is being over-driven and to apply the brake accordingly.

While only the presently preferred embodiment has been described in detail, as will be apparent to those skilled in the art, modifications and improvements may be made to the device disclosed herein without departing from the scope of the invention. Accordingly, it is not intended that the invention be limited except as by the appended claims.

What is claimed is:

1. An aircraft seat actuator assembly incorporating an anti-back drive mechanism, the assembly comprising:
an electric motor having an output shaft;
a seat actuator having an input gear;
an anti-back drive mechanism, comprising;
a housing having an interior wall;
an input member having at least one driving member at one end, and being coupled to the output shaft of the motor at another end;
an output member having at least one driven member at one end, and being coupled to the input gear of the actuator at another end;
the driving members adapted to drive the driven members, the driving and driven members being rotatable within the housing, wherein the driving members drive the driven members CW and CCW;
each driven member including at least one cam surface, wherein a rolling member rides over the cam surfaces; and
wherein when the driving members stop rotating, back driving of the driven members causes the rolling member to wedge between the cam surfaces on each driven member and the interior wall of the housing thereby locking each driven member and stopping the back driving; and
the driving members being adapted to disengage the rolling members which prevent rotation of the output member when the driving members drive the driven members to rotate the output member.

2. The aircraft seat actuator assembly incorporating an anti-back drive mechanism of claim 1, further including an additional rolling member disposed on the cam surfaces of each driven member adjacent the existing rolling member; and a biasing spring disposed between the adjacent rolling members on the cam surfaces of each driven member, wherein when rotation of the driving members stops, the biasing spring bias each rolling member into a wedge position between the cam surfaces and the interior wall of the housing, wherein one of the rolling members on each driven member prevents the output member from back driving in a CW direction and the other rolling member prevents the output member from back driving in a CCW direction.

3. The aircraft seat actuator assembly incorporating an anti-back drive mechanism of claim 1, wherein each driving member has an inner and an outer abutment face at each end; and each driven member includes an inner abutment face at each end, the inner abutment faces of the driving members being engageble with the inner abutment faces of the driven members in order to drive the driven members.

4. The aircraft seat actuator assembly incorporating an anti-back drive mechanism of claim 3, wherein the outer abutment faces contact and disengage the rolling members preventing CW or CCW rotation of the driven members when the driving members are rotated CW or CCW respectively.

5. The aircraft seat actuator assembly incorporating an anti-back drive mechanism of claim 3, wherein the inner abutment faces are stepped tangentially inwardly from the outer abutment faces and wherein the outer abutment faces contact and disengage the rolling members preventing CW or CCW rotation of the driven members prior to the inner abutment faces of the driving members contacting the inner abutment faces of driven members when the driving members are rotated CW or CCW respectively.

6. The no-back drive aircraft seat actuator assembly of claim 5, wherein the inner and outer abutment faces are formed as an S-curve.

7. The aircraft seat actuator assembly incorporating an anti-back drive mechanism of claim 3, wherein the outer abutment faces of the driving members are arcuate in shape.

8. The aircraft seat actuator assembly incorporating an anti-back drive mechanism of claim 1, wherein the input member includes an intermediate ring disposed adjacent the driving members, wherein the intermediate ring rotatably supports the input member within the housing.

9. The aircraft seat actuator assembly incorporating an anti-back drive mechanism of claim 1, wherein the output member includes an intermediate ring disposed adjacent the driven members, wherein the intermediate ring rotatably supports the output member within the housing.

10. The aircraft seat actuator assembly incorporating an anti-back drive mechanism of claim 1, wherein the interior wall of the housing is a cylindrical surface.

11. A no-back drive aircraft seat actuator assembly, the assembly comprising:
an electric motor having an output shaft;
a seat actuator having an input gear;
an anti-back drive mechanism, comprising;
a housing having an interior wall;
an input member having at least one driving member at one end, and being coupled to the output shaft of the motor at another end;
an output member having at least one driven member at one end, and being coupled to the input gear of the actuator at another end;
the driving members adapted to drive the driven members, the driving and driven members being rotatable within the housing, wherein the driving members drive the driven members CW and CCW;
each driven member including two adjacent cam surfaces, wherein a rolling member is disposed on each adjacent cam surface;
a biasing spring disposed between each adjacent rolling member on the adjacent cam surfaces of each driven member, wherein when rotation of the driving members stops, the biasing spring bias each rolling member into a wedge position between the cam surfaces and the interior wall of the housing, wherein one of the rolling members on each driven member prevents the output member from back driving in a CW direction and the other rolling member prevents the output member from back driving in a CCW direction; and
the driving members are adapted to disengage the respective rolling members which prevent CW and CCW rotation of the output member when the driving members drive the driven members to rotate CW and CCW respectively.

12. The no-back drive aircraft seat actuator assembly of claim 11, wherein each driving member has an inner and an outer abutment face at each end; and each driven member includes an inner abutment face at each end, the inner abutment faces of the driving members being engageble with the inner abutment faces of the driven members in order to drive the driven members.

13. The no-back drive aircraft seat actuator assembly of claim 12, wherein the outer abutment faces contact and disengage the rolling members preventing CW or CCW rotation of the driven members when the driving members are rotated CW or CCW respectively.

14. The no-back drive aircraft seat actuator assembly of claim 12, wherein the inner abutment faces are stepped inwardly from the outer abutment faces and wherein the outer abutment faces contact and disengage the rolling members preventing CW or CCW rotation of the driven members prior to the inner abutment faces of the driving members contacting the inner abutment faces of driven members when the driving members are rotated CW or CCW respectively.

15. The no-back drive aircraft seat actuator assembly of claim 14, wherein the inner and outer abutment faces are formed as an S-curve.

16. The no-back drive aircraft seat actuator assembly of claim 11, wherein the input member includes an intermediate ring disposed adjacent the driving members, wherein the intermediate ring rotatably supports the input member within the housing.

17. The no-back drive aircraft seat actuator assembly of claim 11, wherein the output member includes an intermediate ring disposed adjacent the driven members, wherein the intermediate ring rotatably supports the output member within the housing.

18. The aircraft seat actuator assembly incorporating an anti-back drive mechanism of claim 11, wherein the adjacent cam surfaces meet at an apex and slope downwardly therefrom.

19. A reclining aircraft seat with anti-back drive capability, the seat comprising:
a seat having a first portion and a second portion;
the second portion being pivotally connected to the first portion;
an actuator assembly, the actuator assembly being fixed to the first portion and coupled to the second portion in such manner that the actuator assembly may raise or lower the seat-back, the actuator assembly comprising;
an electric motor having an output shaft;
an actuator having an input gear;
an anti-back drive mechanism, comprising;
a housing having an interior wall;
an input member having at least one driving member at one end, and being coupled to the output shaft of the motor at another end;
an output member having at least one driven member at one end, and being coupled to the input gear of the actuator at another end;
the driving members adapted to drive the driven members, the driving and driven members being rotatable within the housing, wherein the driving members drive the driven members CW and CCW;
each driven member including at least one cam surface, wherein a rolling member rides over the cam surfaces; and
wherein when the driving members stop rotating, back driving of the driven members causes the rolling member to wedge between the cam surfaces on each driven member and the interior wall of the housing thereby locking each driven member and stopping the back driving; and
the driving members being adapted to disengage the rolling members which prevent rotation of the output member when the driving members engage the driven members to rotate the output member.

20. The reclining aircraft seat with anti-back drive capability of claim 19, further including a second rolling member disposed on the cam surfaces of each driven member adjacent the existing rolling member; and a biasing spring disposed between the adjacent rolling members on the cam surfaces of each driven member, wherein when rotation of the driving members stops, the biasing spring bias each rolling member into a wedge position between the cam surfaces and the interior wall of the housing, wherein one of the rolling members on each driven member prevents the output member from back driving in a CW direction and the other rolling member prevents the output member from back driving in a CCW direction.

21. The reclining aircraft seat with anti-back drive capability of claim 19, wherein each driving member has an inner and an outer abutment face at each end; and each driven member includes an inner abutment face at each end, the inner abutment faces of the driving members being engageble with the inner abutment faces of the driven members in order to drive the driven members.

22. The reclining aircraft seat with anti-back drive capability of claim 21, wherein the outer abutment faces contact and disengage the rolling members preventing CW or CCW rotation of the driven members when the driving members are rotated CW or CCW respectively.

23. The reclining aircraft seat with anti-back drive capability of claim 21, wherein the inner abutment faces are stepped tangentially inwardly from the outer abutment faces and wherein the outer abutment faces contact and disengage the rolling members preventing CW or CCW rotation of the driven members prior to the inner abutment faces of the driving members contacting the inner abutment faces of driven members when the driving members are rotated CW or CCW respectively.

24. The no-back drive aircraft seat actuator assembly of claim 21, wherein the inner and outer abutment faces are formed as an S-curve.

25. The aircraft seat actuator assembly incorporating an anti-back drive mechanism of claim 19, wherein the input member includes an intermediate ring disposed adjacent the driving members, wherein the intermediate ring rotatably supports the input member within the housing.

26. The aircraft seat actuator assembly incorporating an anti-back drive mechanism of claim 19, wherein the output member includes an intermediate ring disposed adjacent the driven members, wherein the intermediate ring rotatably supports the output member within the housing.

27. A reclining aircraft seat with anti-back drive capability, the seat comprising:
a seat portion;
a seat-back pivotally connected to the seat portion;
an actuator assembly, the actuator assembly being fixed to the seat portion and coupled to the seat-back in such manner that the actuator assembly may raise or lower the seat-back, the actuator assembly comprising;
an electric motor having an output shaft;
an actuator having an input gear;
an anti-back drive mechanism, comprising;
a housing;
an input member having a plurality of driving members at one end, and being coupled to the output shaft of the motor at another end;
an output member having a plurality of driven members at one end, and being coupled to the input gear of the actuator at another end;
the driving members adapted to engage the driven members, the driving and driven members being enclosed and rotatable within the housing, wherein the driving members drive the driven members CW and CCW; and
means for locking the driven members to the housing when the output member is rotated by passenger induced loads.

28. The reclining aircraft seat with anti-back drive capability of claim 27, wherein the means for locking the driven members to the housing when the driven members are rotated by passenger induced loads comprises:
two adjacent cam surfaces formed on each driven member, wherein a rolling member is disposed on each adjacent cam surface; and
a biasing spring disposed between each adjacent rolling member on the adjacent cam surfaces of each driven member, wherein when rotation of the driving members stops, the biasing spring bias each rolling member into a wedge position between the cam surfaces and the interior wall of the housing, wherein one of the rolling members on each driven member prevents the output member from back driving in a CW direction and the other rolling member prevents the output member from back driving in a CCW direction.

29. The reclining aircraft seat with anti-back drive capability of claim 28, wherein the driving members are adapted to disengage the respective rolling members which prevent CW and CCW rotation of the output member when the driving members engage the driven members to rotate CW and CCW respectively.

30. The reclining aircraft seat with anti-back drive capability of claim 27, wherein the means for locking the driven members to the housing when the driven members are rotated by passenger induced loads comprises:
two adjacent cam surfaces formed on each driven member, wherein a single rolling member rides over both cam surfaces; and
wherein when the driving members stop rotating, back driving of the driven members causes each rolling member to wedge between one of the adjacent cam surfaces on each driven member and the interior wall of the housing thereby locking each driven member and stopping the back driving.

31. The reclining aircraft seat with anti-back drive capability of claim 30, wherein the driving members are adapted to disengage the rolling members which prevent rotation of the output member when the driving members engage the driven members to rotate the output member.

32. An aircraft seat actuator assembly incorporating an anti-back drive mechanism, the assembly comprising:
an electric motor having an output shaft;
an actuator having an input gear;
an anti-back drive mechanism, comprising;
a housing;
an input member having a plurality of driving members at one end, and being coupled to the output shaft of the motor at another end;
an output member having a plurality of driven members at one end, and being coupled to the input gear of the actuator at another end;
the driving members adapted to engage the driven members, the driving and driven members being enclosed and rotatable within the housing, wherein the driving members drive the driven members CW and CCW; and
means for locking the driven members to the housing when the output member is rotated by passenger induced loads.
